(19) United States
(12) Patent Application Publication
(10) Pub. No.: US 2006/0201054 A1
(43) Pub. Date: Sep. 14, 2006

(54) Insect repelling or killing resin product

(76) Inventors: Nobuo Katsuura, Sagamihara-shi (JP); Miyoko Ehara, Sagamihara-shi (JP)

Correspondence Address: CARR & FERRELL LLP, 2200 GENG ROAD, PALO ALTO, CA, 94303, US

(21) Appl. No.: 11/370,212

(22) Filed: Mar. 6, 2006

(30) Foreign Application Priority Data
Mar. 7, 2005 (JP) 2005-062943

(51) Int. Cl. A01M 13/00; A01M 1/20

(52) U.S. Cl. 43/129; 43/132.1; 43/125

(57) ABSTRACT

An insect repelling or killing resin product that is attachable to long target(s) and includes: a belt piece made of a resin containing at least either an insect-repelling agent or an insecticide formed in a belt shape, that can be wound around the long target; and an engaging member located at one end of the belt piece. Plural engagement parts capable of engaging with the engaging member are arranged side by side on the belt piece at positions spaced apart from each other along the longitudinal direction of the belt piece. When the belt piece is wound around the long target, the engaging member is made to engage with one of the engagement parts.

### CROSS-REFERENCES TO RELATED APPLICATIONS This application relates to and claims priority from Japanese Patent Application No. 2005-62943, filed on Mar. 7, 2005, the entire disclosure of which is incorporated herein by reference

### BACKGROUND OF THE INVENTION

The present invention relates to an insect repelling or killing resin product (pest-control product) that has the effect of exterminating pests by repelling or killing them, that is applied to long target(s) to be protected against damage caused by the pests Equipment installed outdoors such as automatic vending machines usually have a problem in that pests such as ants, cockroaches, spiders, and centipedes flock around and enter the equipment. These pests often enter equipment by following cords or similar of the equipment or crawling through gaps in the equipment.

The inside of equipment such as traffic signal control units can be considered a comfortable and safe environment for pests because it is not influenced by rain or wind and is maintained at a constant temperature even in the winter, and the pests are protected from enemy attacks.

Various defensive measures have been suggested to prevent the infestation of pests in equipment. For example, JP-A-3-10632 suggests a product made by placing and securing a pesticide or pest control agent to be held between two tape-shaped sheet base materials at specified spaced positions wherein one side of the tape sheet is adhesive so that the product can be attached to plants such as trees.

However, in the defensive measure in JP-A-3-10632, the sheet base materials need to be fixed to the target that needs to be protected against pests, by applying an adhesive agent, such as a pressure sensitive adhesive double coated tape, to one side of the sheet base materials on which the pesticide or pest control agent is fixed, or by using a fastening device such as a band to fasten the sheet base materials to the target. If the adhesiveness of the adhesive agent decreases, gaps are created between the target and the sheet materials and it becomes difficult to prevent pest infestation. If the adhesiveness further decreases, the problem of the sheet base materials falling off the target arises.

Where a fastening device such as a band is used to wind the sheet base materials around the target, the tape-formed sheet base materials are first wound around the target and then the fastening device is used to fasten the sheet base materials to the target. Therefore, the problem is that a great burden will be imposed on the person in charge of the work to attach the sheet base materials to the target, depending on the position of the target where the fastening device is to be attached. Also, the unwound part of the fastening device remaining after being wound around the target sometimes hangs out and becomes a hindrance.

Devices that protect against bird and animal damage on various cables have also been introduced. An example of such a device that protects against bird and animal damage on cables is one disclosed in JP-A-2003-199478, a belt-like sheet made by laminating elastic sheets, and a metallic protective member, wherein the belt-like sheet is wound around cables or similar in a spiral fashion.

Since the protective means described in JP-A-2003-199478 is configured in such a way that the elastic sheets and the metallic protective member are laminated, the belt-like sheet itself is not so flexible. Therefore, when the belt-like sheet is used to bind a plurality of cables, it can barely fit the bundle of cables. Also, since the belt-like sheet does not have a strong fastening force, there is the possibility that gaps may be formed between the cables or between the cables and the belt-like sheet, and that pests may enter the gaps.

### SUMMARY OF THE INVENTION

The present invention was devised in view of the circumstances described above. It is an object of the invention to provide an insect repelling or killing resin product that can prevent formation of gaps between long targets such as cables, pipes, or legs of equipment that should be bound together, or gaps between the long targets and the insect repelling or killing resin product, and can efficiently exterminate pests.

In order to achieve the above-described object, an aspect of the invention provides an insect repelling or killing resin product that is attachable to a long target and includes: a belt piece formed in a belt shape made of a resin containing at least either an insect-repelling agent or an insecticide, that can be wound around the long target; and an engaging member placed at one end of the belt piece; wherein plural engagement parts capable of engaging with the engaging member are arranged side by side on the belt piece at positions spaced apart from each other along the longitudinal direction of the belt piece; and when the belt piece is wound around the long target, the engaging member is made to engage with one of the engagement parts.

Since the insect repelling or killing resin product structured as described above is made of resin and formed in a belt shape, when the insect repelling or killing resin product is wound around a long target, it can easily fit the long target and be firmly fastened to the long target. Accordingly, it is possible to prevent the formation of gaps between the long target and the insect repelling or killing resin product. When binding a plurality of long targets, it is also possible to prevent the formation of gaps between the long targets. Also, since plural engagement parts are arranged side by side along the longitudinal direction of the belt piece, it is possible to select the engagement part with which the engaging member should engage when the insect repelling or killing resin product is wound around the long target(s). Therefore, even if the thickness (or diameter) of the long target or the number of long targets to be bound together is changed, the insect repelling or killing resin product can be tightly attached to the long target(s)/bind the long target(s). Since the insect repelling or killing resin product attached to the long target(s) can efficiently control pests, the long target(s) can be protected against damage caused by the pests.

Moreover, the insect repelling or killing resin product according to the aspect of the invention includes the engaging member and the engagement parts that engage with each other. Therefore, there is no need to bother with securing the belt piece to the long target by, for example, using another fastening device.

The insect repelling or killing resin product can be structured so that it includes a plurality of belt pieces and the belt pieces are joined together. In this configuration, a long side of the belt piece may be connected to a long side of another adjacent belt piece.

Moreover, the insect repelling or killing resin product can be structured so that the belt pieces are connected by a joint part and each belt piece is partially separable from the other belt piece by cutting off the joint part. Because of this structure, each belt piece can be wound around each long target when binding a plurality of long targets. Therefore, it is possible to further ensure that the formation of gaps between the long target(s) and the insect repelling or killing resin product is prevented. It is also possible to further ensure that the formation of gaps between the long targets is prevented when binding a plurality of long targets together.

The insect repelling or killing resin product can be structured so that it includes a plurality of joint parts wherein the joint parts are separated from each other by a slit(s).

The insect repelling or killing resin product may be structured so that the ends of the belt pieces opposite the ends where the engaging members are placed are joined together by the joint part. Also, the ends of the belt pieces opposite the ends where the engaging members are placed may be separated from each other by the slit.

If the ends of the belt pieces opposite the ends where the engaging members are placed are separated from each other by the slit, the slit formed at the ends of the belt pieces may be defined in a tapered shape so that the base end portion of the slit becomes narrower towards its base end. This structure makes it easier to break the joint part from the sharp end (or narrow part) of the tapered shape as a starting point. As a result, a user can easily break the joint part with his/her hand, without using any tool such as scissors or a knife, and thereby easily partially separate the belt pieces.

Also, the slit adjacent to the slit formed at the ends of the belt pieces opposite the ends where the engaging members are placed may be defined so that the part of the adjacent slit opposite the tapered shape described above is tapered toward the slit formed at the ends of the belt pieces.

The belt pieces and the joint part for connecting the belt pieces may be formed integrally. Alternatively, they may be formed separately.

Furthermore, in the insect repelling or killing resin product of the invention, the engaging member is preferably placed along one short-side edge (or the leading edge) of the belt piece. This structure has the effect, in addition to the advantageous effects described above, of allowing the engaging member formed at the top end of the insect repelling or killing resin product to engage with the engagement part. Therefore, the top end of the insect repelling or killing resin product will not become a hindrance.

The engaging member can be a hook, and the engagement part can be a hole or a concave part where the hook engages.

### BRIEF DESCRIPTION OF THE DRAWINGS

FIG. 1 is a perspective view of the front surface of the insect repelling or killing resin product according to an embodiment of the invention.

FIG. 2 is a perspective view of the back surface of the insect repelling or killing resin product shown in FIG. 1.

FIG. 3 is a top view of the insect repelling or killing resin product shown in FIG. 1.

FIG. 4 is a bottom view of the insect repelling or killing resin product shown in FIG. 1.

FIG. 5 is a side view of the insect repelling or killing resin product shown in FIG. 1.

FIG. 6 is a front view of the insect repelling or killing resin product shown in FIG. 1.

FIG. 7 is a sectional view of the insect repelling or killing resin product as taken along line A-A in FIG. 3.

FIG. 8 is a sectional view of the insect repelling or killing resin product as taken along line B-B in FIG. 3.

FIG. 9 is a partially enlarged view of the part circled with chain line C in FIG. 4.

FIG. 10 is a partially enlarged view of the part circled with chain line D in FIG. 5.

FIG. 11 is a diagram explaining a method for using the insect repelling or killing resin product according to the embodiment of the invention.

FIG. 12 is a diagram explaining the method for using the insect repelling or killing resin product according to the embodiment of the invention.

FIG. 13 is a bottom view of part of the insect repelling or killing resin product according to the embodiment of the invention.

### DETAILED DESCRIPTION OF THE INVENTION

The insect repelling or killing resin product according to a preferred embodiment of this invention is described below in detail with reference to the attached drawings. The embodiment described below is for the purpose of describing this invention, but the invention is not limited only to that embodiment. Accordingly, this invention can be utilized in various ways unless those utilizations depart from the gist of the invention.

The term “long target(s)” used in this embodiment means, for example, cords, electric cables, pipes, legs of kitchen fixtures, legs of carrier wagons, and upper parts of casters. However, this embodiment will be described by using cords as an example of the long targets.

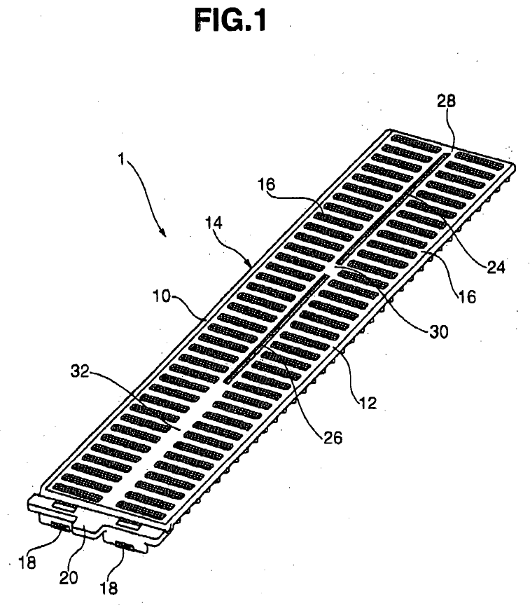

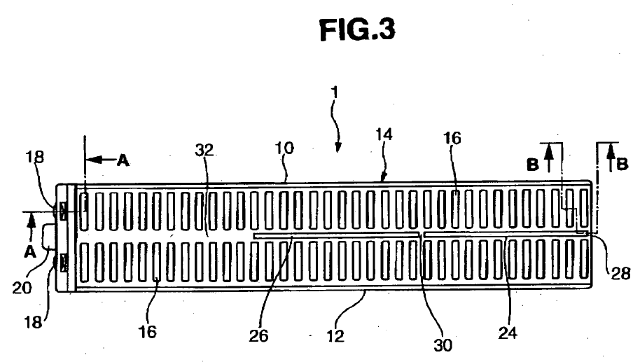

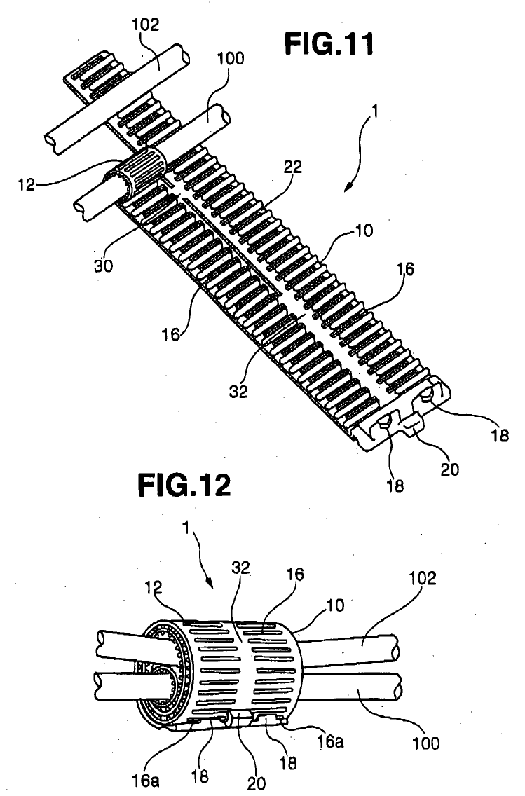

As shown in FIGS. 1 to 5, an insect-repelling/killing resin product 1, the insect repelling or killing resin product according to this embodiment, has a belt-like shape wherein two belt pieceslo and 12 that can be wound around cords 100 and 102 (see FIGS. 11 and 12) are connected in their widthwise direction by short joint parts 28 and 30, and a joint part 32 longer than the joint parts 28 and 30 to constitute a belt unit 14. Hooks 18 described later in detail are formed respectively at one end of the belt pieces 10 and 12.

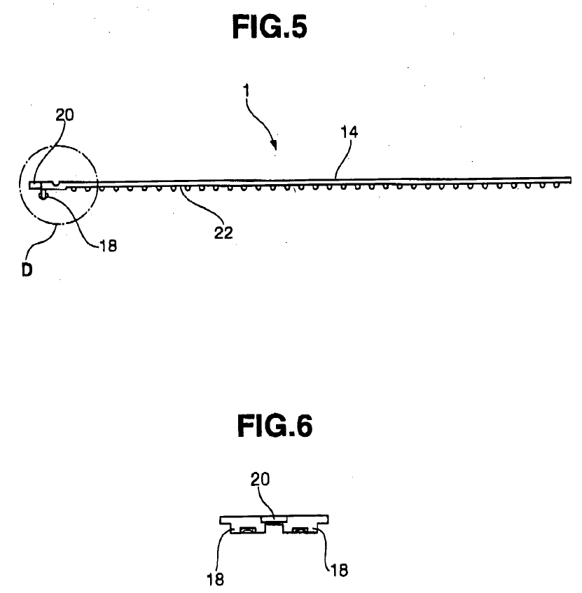

This insect-repelling/killing resin product 1 is formed to achieve a certain degree of thickness enabling flexible manipulation, as can be seen in its side view in FIG. 5. An appropriate thickness for the insect-repelling/killing resin product 1 is set in consideration of the tensile strength of the insect-repelling/killing resin product 1 that will not cause it to break when it is attached to the cords 100 and 102.

Generally rectangular holes 16 are formed at evenly spaced positions on the belt pieces 10 and 12 along their longitudinal direction. The hook 18 can engage with each hole 16. There is no particular limit on the number of holes 16. However, the larger the number of holes 16, the more adjustable the insect-repelling/killing resin product 1 becomes, because the engagement position of the hooks 18 can be adjusted when the insect-repelling/killing resin product 1 is attached to the long targets. The insect-repelling/killing resin product 1 with many holes 16 can be used for long targets of various diameters, and can be adjusted according to the number of cords 100 and 102 to be bound by the insect-repelling/killing resin product 1. Therefore, it is preferable that a large number of holes 16 be made in the insect-repelling/killing resin product 1.

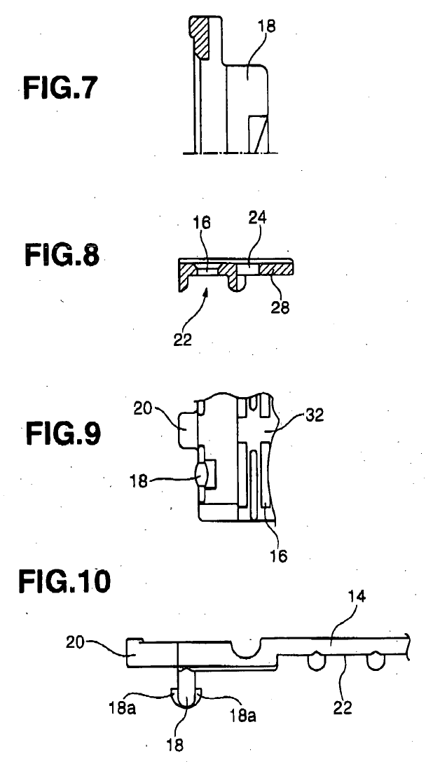

As shown in FIGS. 6, 7, and 10, the hook 18 that can engage with the hole 16 protrudes from and is formed at one end of each belt piece 10 and 12. Arrow-shaped bulges 18a are formed at the top of the hook 18 as shown in FIG. 10. These bulges 18a prevent the hook 18 from easily coming out of the hole 16 once the hook 18 is inserted into the hole 16.

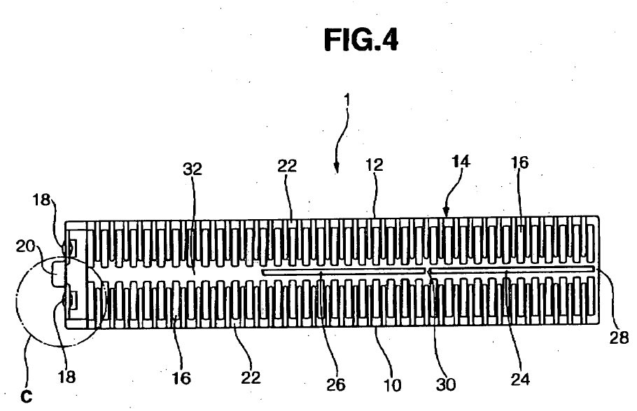

Also, a convex part 20 is formed near the hooks 18 as shown in FIGS. 4, 9, and 10 so that the insect-repelling/killing resin product 1 can be easily detached from the cords 100 and 102.

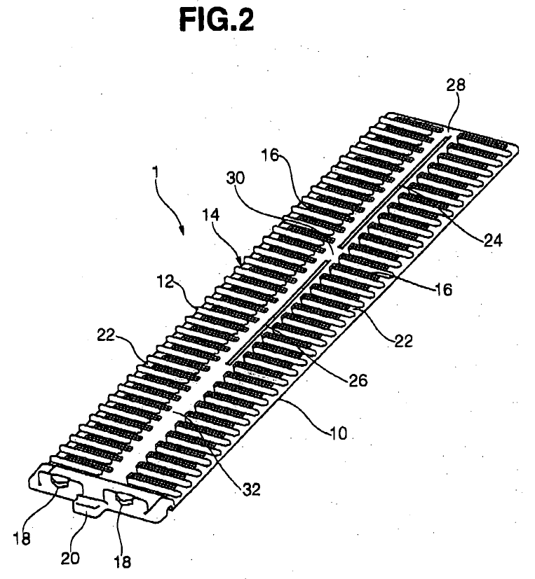

Moreover, plural protrusions are formed at evenly spaced positions on the back side of the insect-repelling/killing resin product 1 as shown in FIGS. 2, 8, and 10. Grooves 22 are defined between the adjacent protrusions. These grooves 22 help the belt unit 14 bend more easily.

As shown in FIGS. 1 to 4, a slit 24 is formed between the joint part 28 and the joint part 30, and a slit 26 is formed between the joint part 30 and the joint part 32. According to this embodiment, these slits 24 and 26 are provided in the area closer to the end of the belt unit 14 opposite the end where the hooksl8 and the convex part 20 are formed. These slits 24 and 26 are provided so that the joint parts 28 and 30 can be easily severed with, for example, nippers in order to partially separate the belt pieces 10 and 12 (see FIG. 11).

Incidentally, the insect-repelling/killing resin product 1 according to this embodiment can be used without cutting off the joint part 28 or 30.

Next, the insect-repelling agent or insecticide will be explained. The insect-repelling agent or insecticide is a medicinal agent having insect-elimination efficacy [symbol] [symbol] . Examples of the insect-repelling agent or insecticide include compounds with insect-repelling efficacy [symbol] [symbol] , compounds with insect-killing/damaging efficacy [symbol] [symbol] , and compounds with insect antifeedant efficacy [symbol] [symbol] and insect growth control efficacy [symbol] [symbol] [symbol] .

Specific examples of the insect-repelling agent or insecticide include: pyrethroid compounds [symbol] [symbol] ; carbamate compounds [symbol] [symbol] [symbol] ; organic phosphorous compounds; isomers, derivatives, and analogues of the aforementioned compounds; and other compounds having insect growth control efficacy.

As the resin constituting a component containing the insect-repelling agent or insecticide, at least one type of resin is selected from polyacetal resins and polyamide resins. Since the insect-repelling/killing resin product 1 according to this embodiment is formed in a thin and generally flat shape as shown in FIG. 5, use of the above-mentioned resins can provide the insect-repelling/killing resin product 1 with flexibility with a certain degree of strength to bind the long targets.

It is also preferable that a compound to dissolve and maintain the insect-repelling agent or insecticide in the resin and give controlled-release properties to the resin is contained in the resin. As a compound to dissolve and maintain the insect-repelling agent or insecticide in the resin and give controlled-release properties to the resin, at least one type of compound can be selected from sulfonamide derivatives, sulfonate derivatives, carboxylic acid amide derivates, and carboxylate derivatives.

Inclusion of the compound for providing controlled-release properties in the resin enables the insect-repelling agent or insecticide to be released from the resin product over a long period of time. The insect-repelling or killing effect of the insect-repelling/killing resin product 1 according to this embodiment can be maintained for about 10 years.

The insect-repelling/killing resin product 1 according to this embodiment can be formed by a known molding method such as injection molding.

Next, the method for using the insect-repelling/killing resin product 1 according to this embodiment will be described below. FIGS. 11 and 12 are diagrams explaining the method for using the insect-repelling/killing resin product 1. FIGS. 11 and 12 illustrate an example in which the insect-repelling/killing resin product 1 according to this embodiment is attached to two cords 100 and 102.

In order to bind the two cords 100 and 102, the joint part 28 shown in FIG. 1 is severed in advance to partially separate the belt pieces 10 and 12. Then as shown in FIG. 11, the back side of the insect-repelling/killing resin product 1 is used and the belt piece 10 is wound from its end around the cord 100. Subsequently, the belt piece 12 is wound from its end around the cord 102. After the belt pieces 10 and 12 are wound around the cords 100 and 102 separately to the position of the joint part 30, the belt pieces 10 and 12 are wound together around the cords 100 and 102.

After the belt pieceslo and 12 are wound around the cords 100 and 102, the hooks 18 formed at the end of the belt unit 14 are inserted into the closest holes (for example, 16a in FIG. 12). Consequently, the hooksl8 are locked in the holes 16 and this rather simple method enables the insect-repelling/killing resin product 1 to be attached with considerable fastening force to the cords 100 and 102.

Furthermore, since the belt pieces 10 and 12 are wound from their ends around the cords 100 and 102 and then the hooksl8 formed at the end of the belt unit 14 are locked in the holes 16, there is no remaining unwound part of the belt unit 14 hanging outside, unlike the case of a conventional fastening band with some part left unwound, after the insect-repelling/killing resin product 1 is attached to the cords 100 and 102. In other words, the drawback of the conventional fastening band can be overcome.

The insect-repelling/killing resin product 1 can be detached from the cords 100 and 102 shown in FIG. 12 by holding the convex part 20 and pulling the hooks 18 out of the holes 16a, thereby releasing its ‘locked’ status.

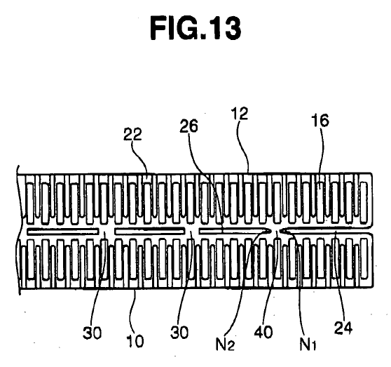

This embodiment described the case where the slits 24 and 25 are formed and the joint parts 28 and/or 30 are severed in order to separate the belt pieces 10 and 12. The means of separating the belt pieces 10 and 12 is not limited to the above-described example; however, it is also possible to partially separate the belt pieces 10 and 12 by forming an easily separable clipping line such as a perforated line between the belt pieces 10 and 12 and cutting off the clipping line. This embodiment also described the case where the belt pieces 10 and 12 are connected by the joint part 28 at the end of the insect-repelling/killing resin product 1 opposite the end where the hooks 18 of the belt pieces 10 and 12 are formed. The invention is not limited to this configuration; however, the end of the insect-repelling/killing resin product 1 opposite the end where the hooks 18 of the belt pieces 10 and 12 are formed may be separated in advance as shown in FIG. 13. In this case, a tapered notch N₁ whose width becomes narrower toward a joint part 40 may be formed at the end of the slit 24 adjacent to the joint part 40. A tapered notch N₂ whose width becomes narrower toward the joint part 40 may also be formed at the end of the slit 26 adjacent to the joint part 40.

These notches enable the user to easily separate the part of the belt pieces 10 and 12 with his/her hands without using any tool, such as nippers. Moreover, this embodiment described an example where the two belt pieces 10 and 12 are connected in their widthwise direction. However, the invention is not limited to this configuration, and the width (the length of the direction substantially perpendicular to the longitudinal direction) of one belt piece may be extended or the number of belt pieces to be connected may be increased to three or more according to the number of cords (long targets) to be bound together. Also, a simple configuration of the belt piecelo with the hook 18 may be applied.

Furthermore, this embodiment described the case where the hooks 18 are formed as the engaging members and the holes 16 are made as the engagement parts. However, the invention is not limited to this configuration, and the shapes of the engaging members and the engagement parts are not particularly limited as long as they can engage with each other. For example, the engagement parts can be concave parts or grooves where the hooks 18 can engage.

Also, another insect-repelling/killing resin product 1 the same as the insect-repelling/killing resin product 1 may be prepared, and the hooks 18 of one insect-repelling/killing resin product 1 may be inserted into the holes 16 in the belt pieces 10 and 12 of the other insect-repelling/killing resin product 1, and these two insect-repelling/killing resin products may be connected along their longitudinal direction. As a result, it is possible to deal with, for example, the case where the outer circumference of the long targets is longer than the length of a single insect-repelling/killing resin product 1. Needless to say, the length of the insect-repelling/killing resin product 1 can be adjusted as appropriate.

This embodiment described the insect-repelling/killing resin product 1 made of resin containing the insect-repelling agent or insecticide. However, the insect repelling or killing resin product according to the invention may be made of at least either of the insect-repelling agent or the insecticide. In other words, the insect repelling or killing resin product may be made of a resin containing the insect-repelling agent, or a resin containing the insecticide, or a resin containing both the insect-repelling agent and the insecticide.

Moreover, this embodiment described the product made of the resin containing the insect-repelling agent or insecticide. However, the invention can be applied as a resin product, even without containing the insect-repelling agent, to bind a plurality of long targets by utilizing the characteristics of the shape of the resin product according to the invention. Specifically speaking, the resin product is made by molding a resin into a belt shape so that it can be wound around long targets; and the resin product includes plural belt pieces (each formed in the belt shape) connected to each other and partially separable from each other, hooks provided at one end of the belt unit, and holes in the belt pieces where the hooks can be locked. This resin product can considerably firmly bind the plural long targets.

The belt piece with a plurality of holes according to the invention has flexibility with a certain degree of strength to bind the long targets. Accordingly, even when a plurality of long targets such as cables should be bound together, it is possible to considerably firmly wind the belt piece around the long targets. Also, the entire belt piece can be wound around the long targets without leaving any part of the belt piece unwound, and the engaging member is provided at the end of each belt piece and can be directly fixed to the hole. Therefore, there is no remaining unwound part of the belt piece or separately employed fastening device that would otherwise become a hindrance. As a result, the insect repelling or killing resin product according to this invention can effectively work on pests such as insects.

What is claimed is:

1. An insect repelling or killing resin product that is attachable to a long target, the insect repelling or killing resin product comprising:
a belt piece formed in a belt shape made of a resin containing at least either an insect-repelling agent or an insecticide, that can be wound around the long target; and
an engaging member placed at one end of the belt piece;
wherein plural engagement parts capable of engaging with the engaging member are arranged side by side on the belt piece at positions spaced apart from each other along the longitudinal direction of the belt piece; and when the belt piece is wound around the long target, the engaging member is made to engage with one of the engagement parts.

2 . The insect repelling or killing resin product according to claim 1, comprising a plurality of belt pieces wherein the belt pieces are joined together.

3. The insect repelling or killing resin product according to claim 2, wherein a long side of the belt piece is connected to a long side of another belt piece adjacent to the former belt piece.

4 . The insect repelling or killing resin product according to claim 2 or 3, wherein the belt pieces are connected by a joint part and each belt piece is partially separable from the other belt piece by severing the joint part.

5. The insect repelling or killing resin product according to claim 4, comprising a plurality of joint parts wherein the joint parts are separated from each other by a slit.

6 . The insect repelling or killing resin product according to claim 4, wherein the ends of the belt pieces opposite the ends where the engaging members are placed are joined together by the joint part.

7. The insect repelling or killing resin product according to claim 4, wherein the ends of the belt pieces opposite the ends where the engaging members are placed are separated from each other by a slit.

8. The insect repelling or killing resin product according to claim 7, wherein the slit formed at the ends of the belt pieces opposite the ends where the engaging members are placed is defined in a tapered shape so that the base end portion of the slit becomes narrower towards its base end.

9. The insect repelling or killing resin product according to claim 8, wherein the slit adjacent to the slit formed at the ends of the belt pieces opposite the ends where the engaging members are placed is defined so that the part of the adjacent slit opposite the tapered shape is tapered toward the slit formed at the ends of the belt pieces.

10. The insect repelling or killing resin product according to claim 4, wherein the belt pieces and the joint part for connecting the belt pieces are formed integrally.

11. The insect repelling or killing resin product according to claim 1, wherein the engaging member is placed along one short-side edge of the belt piece.

12. The insect repelling or killing resin product according to claim 1, wherein the engaging member is a hook.

13. The insect repelling or killing resin product according to claim 12, wherein the engagement part is a hole or a concave part with which the hook engages.
